(19) United States
(12) Patent Application Publication
(10) Pub. No.: US 2022/0396699 A1
(43) Pub. Date: Dec. 15, 2022

(54) CURABLE SILICONE RESIN COMPOSITION, SILICONE RESIN CURED MATERIAL, DAM MATERIAL, ENCAPSULANT, AND SEMICONDUCTOR DEVICE

(71) Applicant: SHIN-ETSU CHEMICAL CO., LTD., Tokyo (JP)

(72) Inventors: Sawako SHODA, Annaka-shi (JP); Tomoyuki MIZUNASHI, Annaka-shi (JP)

(73) Assignee: SHIN-ETSU CHEMICAL CO., LTD., Tokyo (JP)

(21) Appl. No.: 17/733,296

(22) Filed: Apr. 29, 2022

(30) Foreign Application Priority Data
May 21, 2021 (JP) 2021-085952

(51) Int. Cl. C08L 83/04

(52) U.S. Cl. CPC C08L 83/04; C08L 2205/03; C08L 2205/025

(57) ABSTRACT

The present invention is a curable silicone resin composition, the composition containing a linear organopolysiloxane, where the linear organopolysiloxane consists solely of a linear organopolysiloxane that has a less than 70% change rate of a contact angle of the linear organopolysiloxane to an Au substrate, the change rate being shown by the following expression (I): [{(contact angle of the linear organopolysiloxane to the Au substrate 2 seconds after dropping the linear organopolysiloxane)−(contact angle of the linear organopolysiloxane to the Au substrate 60 seconds after dropping the linear organopolysiloxane)}/(contact angle of the linear organopolysiloxane to the Au substrate 2 seconds after dropping the linear organopolysiloxane)]*100(%) (I). This provides a curable silicone resin composition that causes little contamination of surrounding members, and in which bleed-out hardly occurs.

### TECHNICAL FIELD

The present invention relates to: a curable silicone resin composition; a dam material and encapsulant containing the composition; a silicone resin cured material formed by curing the composition; and a semiconductor device including the cured material.

### BACKGROUND ART

Silicone resin compositions have low elasticity and low stress, and have excellent reliability regarding heat resistance, electric insulation property, etc. Therefore, silicone resin compositions are widely used for electronic components, uses in semiconductors, and so forth.

However, when a silicone resin composition is used for an electronic component, a semiconductor, or the like, a low-molecular-weight siloxane contained in the silicone resin composition is sometimes a problem. Examples of such problems include clouding, contact fault, adhesion failure, hydrophobization of the surface, etc. caused by the volatilization of low-molecular-weight siloxanes and deposition of the volatilized low-molecular-weight siloxanes on surrounding surfaces.

As a means for solving the problems, for example, Patent Document 1 discloses that the contamination of surroundings during heat-curing can be suppressed by setting the amount of the low-molecular-weight siloxane compounds contained in the addition-curable silicone resin composition to a certain mass % of the entire resin composition or less.

### CITATION LIST

### Patent Literature

Patent Document 1: JP 2008-255227 A

### SUMMARY OF INVENTION

### Technical Problem

In recent years, with the miniaturization of electronic members, members tend to have higher integration and higher density. As a result, a silicone resin composition that is used for an electronic member is required to contain little low-molecular-weight siloxane, and in addition, for the purpose of preventing interference to surrounding members, it is required that there is little bleed-out from the silicone resin composition when the silicone resin composition is applied to a substrate.

However, although the Patent Document 1 mentions the removal of low-molecular-weight siloxanes, there is no mention of bleed-out from the silicone resin composition, and the Patent Document 1 is not sufficient for fulfilling the demands required of members for use in electronic materials in recent years.

The present invention has been made in view of the problems, and an object thereof is to provide a curable silicone resin composition that causes little contamination of surrounding members, and in which bleeding out hardly occurs.

### Solution to Problem

To achieve the object, the present invention provides a curable silicone resin composition, the composition comprising a linear organopolysiloxane, wherein the linear organopolysiloxane consists solely of a linear organopolysiloxane that has a less than 70% change rate of a contact angle of the linear organopolysiloxane to an Au substrate, the change rate being shown by the following expression (I):

[((contact angle of the linear organopolysiloxane to the Au substrate 2 seconds after dropping the linear organopolysiloxane)−(contact angle of the linear organopolysiloxane to the Au substrate 60 seconds after dropping the linear organopolysiloxane)}/(contact angle of the linear organopolysiloxane to the Au substrate 2 seconds after dropping the linear organopolysiloxane)]×100(%) (I)

Such a curable silicone resin composition causes little contamination of surrounding members, and bleeding out hardly occurs.

Furthermore, in the present invention, the curable silicone resin composition preferably comprises:

(A-1) an organopolysiloxane having at least two alkenyl groups bonded to silicon atoms in one molecule thereof;
(A-2) an organopolysiloxane having a resin structure containing at least two alkenyl groups in one molecule thereof;
(B) an organohydrogenpolysiloxane having at least two hydrogen atoms bonded to silicon atoms, that is, SiH groups in one molecule thereof and having a less than 70% change rate of the contact angle to the Au substrate, the change rate being shown by the expression (I);
(C) a platinum group metal-based catalyst; and
(D) an inorganic filler, and the linear organopolysiloxane is preferably contained as the component (A-1).

In the present invention, such a curable silicone resin composition can be used suitably.

Furthermore, in the present invention, the component (A-2) preferably contains an organopolysiloxane having an alkenyl group-containing resin structure having at least one of an SiO_{4/2} unit and an R¹SiO_{3/2} unit, wherein R¹ represents a substituted or unsubstituted alkyl group having 1 to 10 carbon atoms, an alkenyl group having 2 to 10 carbon atoms, or an aryl group having 6 to 10 carbon atoms.

Such a curable silicone resin composition causes less contamination of surrounding members, and bleed-out occurs less.

Furthermore, in the present invention, a viscosity of the curable silicone resin composition at a strain rate of 1 (1/s) is preferably 2.0 or more times as much as a viscosity at a strain rate of 10 (1/s).

Such a curable silicone resin composition causes even less contamination of surrounding members, and bleed-out occurs even less.

In addition, the present invention provides a silicone resin cured material formed by curing the above-described curable silicone resin composition.

Such a silicone resin cured material causes little contamination of surrounding members, and bleed-out hardly occurs in the cured material.

In addition, the present invention provides a dam material and an encapsulant comprising the above-described curable silicone resin composition.

The inventive curable silicone resin composition can be used suitably for such members.

In addition, the present invention provides a semiconductor device comprising the above-described silicone resin cured material.

In such a semiconductor device, there is little contamination from the silicone resin to surrounding members, and bleed-out hardly occurs, so that interference of surrounding members can be prevented sufficiently.

### Advantageous Effects of Invention

The inventive curable silicone resin composition can provide a curable silicone resin composition that causes little contamination of surrounding members, hardly bleeds out, and is provided with accurate flow controllability when used for electronic components as an encapsulant or a dam material.

### BRIEF DESCRIPTION OF DRAWINGS

FIG. 1 is a graph in which the detected amount of Si has been plotted against the distance from the silicone resin cured material when the curable silicone resin composition of each Example of the present invention and each Comparative Example was applied to an Au substrate and cured, and analyzed by SEM-EDX.

### DESCRIPTION OF EMBODIMENTS

As described above, there have been demands for the development of a curable silicone resin composition in which there is little contamination of surrounding members and bleed-out hardly occurs.

To solve the problems, the present inventors have earnestly studied and found out that by using a linear organopolysiloxane in which the change rate of the contact angle of the linear organopolysiloxane to an Au substrate is within a specific range, the change rate being shown by the expression (I) below, it is possible to provide a curable silicone resin composition in which bleed-out hardly occurs. Thus, the present inventors have arrived at the present invention.

That is, the present invention is a curable silicone resin composition, the composition comprising a linear organopolysiloxane, wherein the linear organopolysiloxane consists solely of a linear organopolysiloxane that has a less than 70% change rate of a contact angle of the linear organopolysiloxane to an Au substrate, the change rate being shown by the following expression (I):

[{(contact angle of the linear organopolysiloxane to the Au substrate 2 seconds after dropping the linear organopolysiloxane)−(contact angle of the linear organopolysiloxane to the Au substrate 60 seconds after dropping the linear organopolysiloxane)}/(contact angle of the linear organopolysiloxane to the Au substrate 2 seconds after dropping the linear organopolysiloxane)]×100(%) (I)

Hereinafter, the present invention will be described in detail, but the present invention is not limited thereto.

### [Curable Silicone Resin Composition]

The inventive curable silicone resin composition contains a linear organopolysiloxane, and the linear organopolysiloxane consists solely of a linear organopolysiloxane that has a less than 70% change rate of a contact angle of the linear organopolysiloxane to an Au substrate. Here, the change rate of the contact angle is shown by the following expression (I):

[((contact angle of the linear organopolysiloxane to the Au substrate 2 seconds after dropping the linear organopolysiloxane)−(contact angle of the linear organopolysiloxane to the Au substrate 60 seconds after dropping the linear organopolysiloxane)}/(contact angle of the linear organopolysiloxane to the Au substrate 2 seconds after dropping the linear organopolysiloxane)]×100(%) (I)

Note that regarding the contact angle in the present invention, the contact angle of the linear organopolysiloxane to the Au substrate was measured by using a contact angle meter (automatic surface tensiometer PD-V manufactured by Kyowa Interface Science Co., Ltd.) at 25° C. at a humidity of 50%. The contact angle was measured from 2 seconds to 60 seconds after dropping a 4-μl droplet onto a sample surface. As the Au substrate, a gold-plated substrate (surface roughness parameters Sₐ: 0.3 μm, S_{z}: 5 μm) was used.

If the change rate, shown by the expression (I), of the contact angle (hereinafter, also referred to as “contact angle change rate”) of the linear organopolysiloxane to the Au substrate is 70% or higher, the organopolysiloxane in the curable silicone resin composition easily wets and spreads on the substrate after the curable silicone resin composition is applied to the substrate. Therefore, bleed-out from the curable silicone resin composition cannot be suppressed.

The inventive curable silicone resin composition preferably contains: components (A-1) and (A-2) as the following component (A), in which a linear organopolysiloxane is contained as the component (A-1); a component (B); a component (C); and a component (D).

(A-1) An organopolysiloxane having at least two alkenyl groups bonded to silicon atoms in one molecule thereof;
(A-2) an organopolysiloxane having a resin structure containing at least two alkenyl groups in one molecule thereof;
(B) an organohydrogenpolysiloxane having at least two hydrogen atoms bonded to silicon atoms, that is, SiH groups in one molecule thereof and having a less than 70% change rate of the contact angle to the Au substrate, the change rate being shown by the expression (I);
(C) a platinum group metal-based catalyst; and
(D) an inorganic filler.

Besides the components (A) to (D), the inventive curable silicone resin composition can contain additives such as (E) a curing inhibitor and (F) an adhesiveness imparting agent as necessary. In the following, these components will be described.

### [(A) Alkenyl Group-Containing Organopolysiloxane]

The component (A) is an alkenyl group-containing organopolysiloxane including the following components (A-1) and (A-2).

### [(A-1) Organopolysiloxane]

(A-1) is an organopolysiloxane having at least two alkenyl groups bonded to silicon atoms in one molecule thereof. The linear organopolysiloxane is contained as the component (A-1), and has a less than 70% change rate of a contact angle to an Au substrate, preferably 65% or less, the change rate being shown by the expression (I).

The component (A-1) preferably contains an aromatic hydrocarbon group having 6 to 12 carbon atoms, preferably an aromatic hydrocarbon group having 6 to 8 carbon atoms in an amount of 15 mol % or more and 40 mol % or less of one molecule. Examples of the aromatic hydrocarbon group include aryl groups such as a phenyl group, a tolyl group, a naphthyl group, and a biphenyl group; aralkyl groups such as a benzyl group, a phenylethyl group, and a phenylpropyl group; etc. In particular, a phenyl group is preferable.

A linear organopolysiloxane having a contact angle change rate within the above-described range causes little wetting of and spreading on a substrate surface when applied to the substrate surface. Therefore, when such a linear organopolysiloxane is used, excellent flow controllability on coating the substrate can be provided, and bleed-out from the curable silicone resin composition can be suppressed.

The blended amount of the organopolysiloxane (A-1) having at least two alkenyl groups bonded to silicon atoms in one molecule thereof can be 5 to 90 mass % relative to the whole of the components (A) to (D), preferably within a range of 10 to 80 mass %.

One kind of the organopolysiloxane having at least two alkenyl groups bonded to silicon atoms in one molecule thereof, the organopolysiloxane having a single viscosity, may be used, or two or more kinds of such an organopolysiloxane having different viscosities and contact angles may be used.

The organopolysiloxane having at least two alkenyl groups bonded to silicon atoms in one molecule thereof preferably has a viscosity at 25° C. of 10 to 100,000 mPa·s, more preferably 100 to 50,000 mPa·s, further preferably 1,000 to 30,000 mPa·s as measured with a Brookfield rotational viscometer in accordance with JIS K 7117-1: 1999. When the viscosity is 10 mPa·s or higher, the compositions hardly bleeds, and when 100,000 mPa·s or lower, workability is not degraded.

Examples of the component (A-1) include the organopolysiloxanes represented by the following structural formulae, but are not limited thereto.

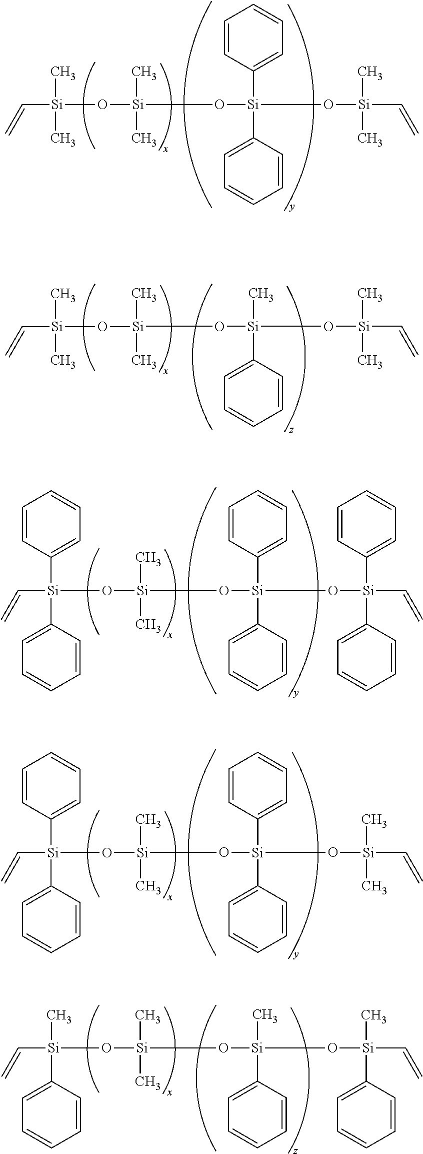

(In the formulae, preferably, “x” is a number of 10 to 5,000, “y” is a number of 1 to 100, “z” is a number of 1 to 100, “y” is 15 mol % or more and 40 mol % or less, and “z” is 15 mol % or more and 40 mol % or less.)

### [(A-2) Organopolysiloxane Having Resin Structure]

The component (A-2) is an organopolysiloxane having a resin structure containing at least two alkenyl groups in one molecule thereof.

The organopolysiloxane having a resin structure (network structure) preferably has a weight-average molecular weight (Mw) of 1,000 to 6,000, more preferably 1,100 to 5,500. When the weight-average molecular weight is 1,000 or more, there is no risk of the curable silicone resin composition becoming brittle. Meanwhile, when the weight-average molecular weight is 6,000 or less, there is no risk of the workability of the curable silicone resin composition being degraded. Therefore, this range is preferable.

Note that the weight-average molecular weight (Mw) in the present invention indicates the weight-average molecular weight measured under the following conditions by gel permeation chromatography (GPC), using polystyrene as a reference substance.

### [Measurement Conditions]

Developing solvent: tetrahydrofuran (THF)
Flow rate: 0.6 mL/min
Detector: Differential refractive index detector (RI)

### Column: TSK Guardcolumn SuperH-L

TSKgel SuperH4000 (6.0 mm I.D.×15 cm×1)

TSKgel SuperH3000 (6.0 mm I.D.×15 cm×1)

TSKgel SuperH2000 (6.0 mm I.D.×15 cm×2)

(each available from Tosoh Corporation)

Column temperature: 40° C.
Sample injection amount: 20 μL (THF solution having a concentration of 0.5 mass %)

The amount of alkenyl groups bonded to silicon atoms contained in the organopolysiloxane having a resin structure is usually 0.01 to 0.5 mol/100 g, preferably 0.05 to 0.3 mol/100 g, more preferably 0.10 to 0.25 mol/100 g. When the amount of the alkenyl groups bonded to silicon atoms is the lower limit or more, the organopolysiloxane has sufficient crosslinking points for the curable silicone resin composition to cure. When the amount is the upper limit or less, there is no risk of toughness being lost due to crosslinking density being too high. Therefore, such a range is preferable.

In the component (A-2), the amount of hydroxy groups bonded to silicon atoms is usually preferably 0.001 to 1.0 mol/100 g, more preferably 0.005 to 0.8 mol/100 g, further preferably 0.008 to 0.6 mol/100 g. When the amount of the hydroxy groups bonded to silicon atoms is the lower limit or more, the organopolysiloxane has sufficient crosslinking points for the curable silicone resin composition to cure. Meanwhile, when the amount is the upper limit or less, there is no risk of toughness being lost due to crosslinking density being too high. Therefore, such a range is preferable.

In the component (A-2), the amount of alkoxy groups bonded to silicon atoms is usually preferably 1.0 mol/100 g or less, more preferably 0.8 mol/100 g or less, further preferably 0.5 mol/100 g or less. The alkoxy groups usually have 1 to 10 carbon atoms, preferably 1 to 5 carbon atoms. When the amount of the alkoxy groups is the upper limit or less, a by-product alcohol gas is hardly generated during curing, so that there is no risk of voids remaining in the cured material. Note that the amounts of hydroxy groups and alkoxy groups bonded to silicon atoms in the present invention indicate values measured by ¹H-NMR and ²⁹Si-NMR.

The component (A-2) (organopolysiloxane having a resin structure) preferably contains an organopolysiloxane having an alkenyl group-containing resin structure having at least one of an SiO_{4/2} unit and an R¹SiO_{3/2} unit. The total of the component (A-2) is more preferably 50 mol % or more, further preferably 60 to 90 mol %. In addition, the component (A-2) usually contains 0 to 60 mol %, preferably 0 to 50 mol % of an SiO_{4/2} unit (Q unit), usually contains 0 to 90 mol %, preferably 30 to 80 mol % of an R¹SiO_{3/2} unit (T unit), usually contains 0 to 50 mol %, preferably 0 to 20 mol % of an (R¹)₂SiO_{2/2} unit (D unit), and usually contains 0 to 50 mol %, preferably 10 to 30 mol % of an (R¹)₃SiO_{1/2} unit (M unit). Here, R¹ represents a substituted or unsubstituted alkyl group having 1 to 10 carbon atoms, an alkenyl group having 2 to 10 carbon atoms, or an aryl group having 6 to 10 carbon atoms.

The R¹s in the M unit, D unit, and T unit each independently represent a substituted or unsubstituted monovalent alkyl group having 1 to 10 carbon atoms, preferably 2 to 5 carbon atoms, an alkenyl group having 2 to 10 carbon atoms, or an aryl group having 6 to 10 carbon atoms, preferably 6 to 8 carbon atoms, provided that the R¹s are not alkynyl groups. Examples of the R¹s include lower alkyl groups such as a methyl group, an ethyl group, a propyl group, and a butyl group; cycloalkyl groups such as a cyclohexyl group; aryl groups such as a phenyl group, a tolyl group, and a xylyl group; aralkyl groups such as a benzyl group, a phenylethyl group, and a phenylpropyl group; alkenyl groups such as a vinyl group, an allyl group, a propenyl group, an isopropenyl group, a butenyl group, a hexenyl group, a cyclohexenyl group, and an octenyl group; and groups obtained by substituting some or all of the hydrogen atoms of these groups with a halogen atom such as fluorine, bromine, or chlorine, a cyano group, etc., for example, a chloromethyl group, a cyanoethyl group, a 3,3,3-trifluoropropyl group, etc. In particular, a methyl group, a phenyl group, and a vinyl group are preferable. More preferably, at least one of the substituents R¹ bonded to the (R¹)₃SiO_{1/2} unit (M unit) is an alkenyl group having 2 to 10 carbon atoms.

Examples of materials for obtaining the SiO_{4/2} unit (Q unit) include sodium silicate, tetraalkoxysilane, a condensate of these, or the like. However, the materials are not limited thereto.

Examples of materials for obtaining the R¹SiO_{3/2} unit (T unit) include organosilicon compounds such as the organotrichlorosilanes and organotrialkoxysilanes represented by the following structural formulae (1), condensates of these, etc. However, the materials are not limited thereto.

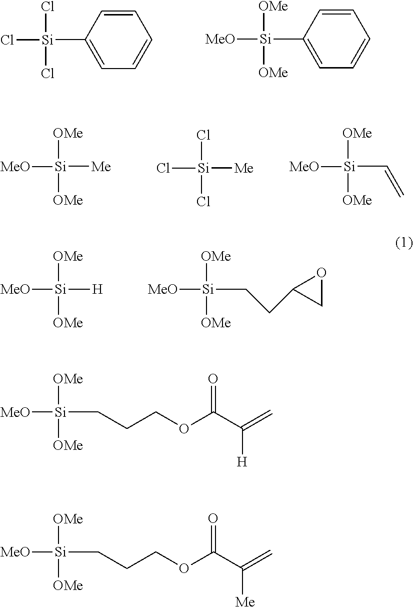

(In the formulae, Me represents a methyl group.)

Examples of materials for obtaining the (R¹)₂SiO_{2/2} unit (D unit) include organosilicon compounds such as the diorganodichlorosilanes, diorganodialkoxysilanes, and cyclic polysiloxanes represented by the following structural formulae (2), the diorganopolysiloxanes of the following structural formula (3) and (4), etc. However, the materials are not limited thereto.

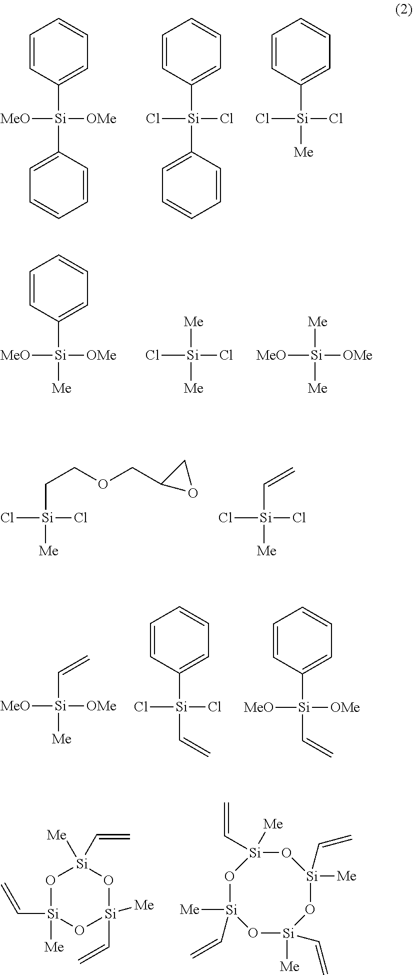

(In the formulae, Me represents a methyl group.)

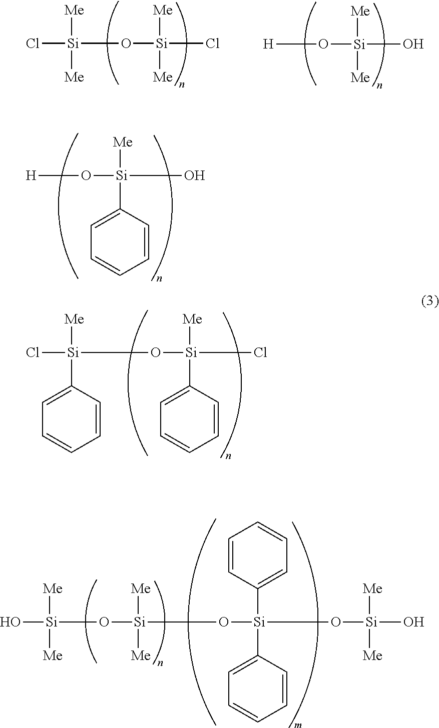

(In the formulae, Me represents a methyl group. “n” represents an integer of 5 to 80 and “m” represents an integer of 5 to 80, provided that n+m≤78.)

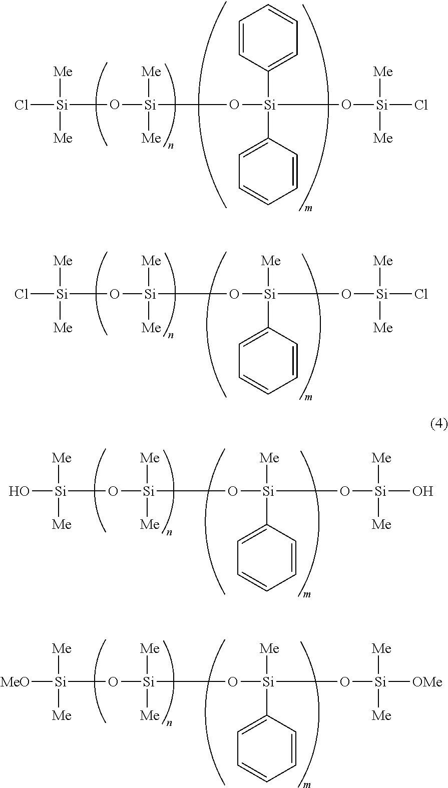

(In the formulae, Me represents a methyl group. “n” represents an integer of 5 to 80 and “m” represents an integer of 5 to 80, provided that n+m≤78.)

Examples of materials for obtaining the (R¹)₃SiO_{1/2} unit (M unit) include organosilicon compounds such as the triorganochlorosilanes, triorganoalkoxysilanes, and hexaorganodisiloxanes represented by the following structural formulae. However, the materials are not limited thereto.

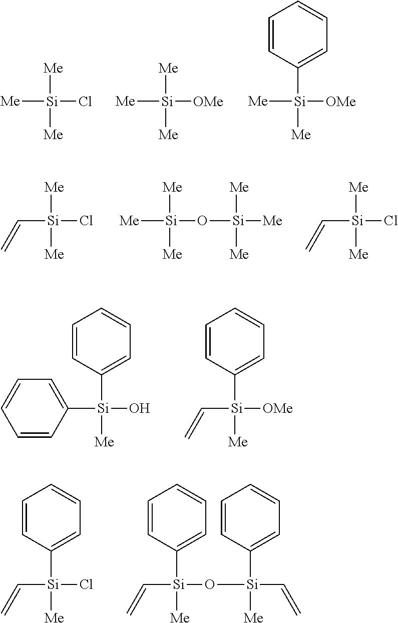

(In the formulae, Me represents a methyl group.)

### [(B) Organohydrogenpolysiloxane]

The component (B) is an organohydrogenpolysiloxane having at least two hydrogen atoms bonded to silicon atoms, that is, SiH groups in one molecule thereof and having a less than 70% change rate of the contact angle to the Au substrate, preferably 65% or less, the change rate being shown by the expression (I).

The component (B) preferably contains an aromatic hydrocarbon group having 6 to 12 carbon atoms, preferably an aromatic hydrocarbon group having 6 to 8 carbon atoms in an amount of 15 mol % or more and 40 mol % or less of one molecule. Examples of the aromatic hydrocarbon group include aryl groups such as a phenyl group, a tolyl group, a naphthyl group, and a biphenyl group; aralkyl groups such as a benzyl group, a phenylethyl group, and a phenylpropyl group; etc. In particular, a phenyl group is preferable.

An organohydrogenpolysiloxane having a contact angle change rate within the above-described range causes little wetting of and spreading on a substrate surface when applied to the substrate surface. Therefore, when such an organohydrogenpolysiloxane is used, bleed-out from the curable silicone resin composition on coating the substrate can be suppressed.

The added amount of the organohydrogenpolysiloxane (B) is such an amount that the proportion of the number of hydrosilyl groups (SiH groups) in the component (B) is 0.1 to 4, preferably 0.4 to 2, more preferably 0.5 to 1.6 relative to the total number of alkenyl groups in the component (A).

Examples of the organohydrogenpolysiloxane (B) include the organopolyhydrogensiloxanes represented by the following structural formulae, but are not limited thereto.

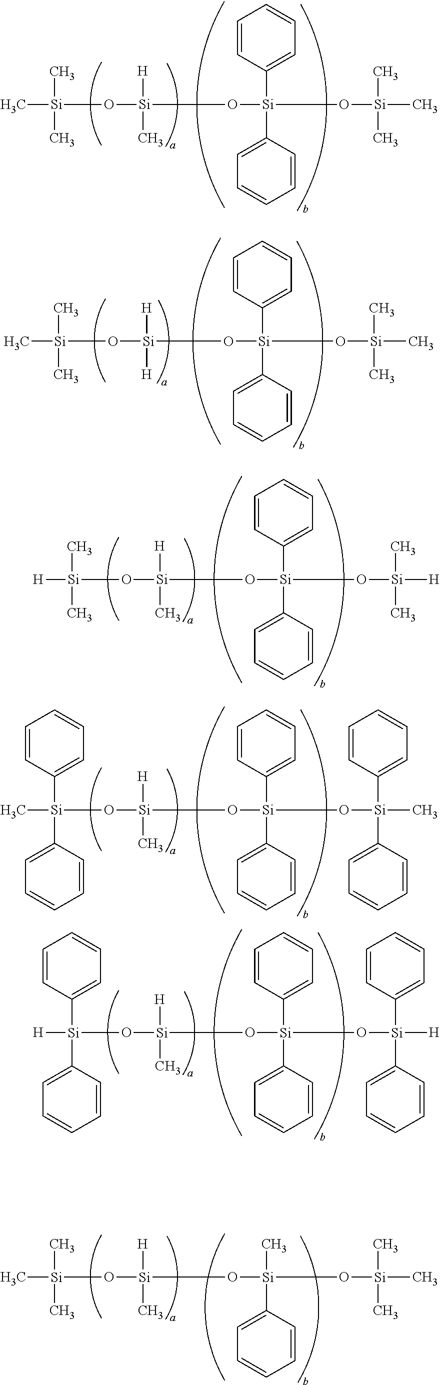

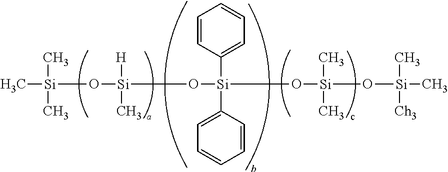

(In the formulae, “a” is a number of 3 to 50, “b” is a number of 5 to 20, preferably, “c” is a number of 1 to 10, “b” is 15 mol % or more and 40 mol % or less, and “c” is 60 mol % or less.)

### [(C) Platinum Group Metal-Based Catalyst]

As the platinum group metal-based catalyst (C), a known addition reaction catalyst can be used as long as the addition-curing reaction between the component (A) and the component (B) contained in the curable silicone resin composition can be promoted. Examples include platinum-based, palladium-based, and rhodium-based catalysts. Considering costs and so forth, examples include platinum-based catalysts such as platinum, platinum black, and chloroplatinic acid, for example, H₂PtCl₆.pH₂O, K₂PtCl₆, HPtCl₆.pH₂O, K₂PtCl₄, K₂PtCl₄.pH₂O, PtO₂.pH₂O, PtCl₄.pH₂O, PtCl₂, H₂PtCl₄.pH₂O (here, “p” is a positive integer), etc., complexes of these and a hydrocarbon such as an olefin, alcohol, or a vinyl group-containing organopolysiloxane, platinum(II) complexes such as bis(acetylacetonato)platinum(II), and platinum(IV) complexes such as (trimethyl)methylcyclopentadienylplatinum(IV). One kind of these catalysts may be used, or a combination of two or more kinds thereof may be used.

The blended amount of the catalyst can be a catalytic amount. For example, when a platinum group metal-based catalyst is used, the catalyst is preferably contained in an amount of 0.0001 to 0.2 parts by mass, more preferably 0.0001 to 0.05 parts by mass in terms of the platinum group metal (mass) relative to a total of 100 parts by mass of the components (A) to (C).

### [(D) Inorganic Filler]

Examples of the inorganic filler include fumed silica, fumed titanium dioxide, etc. In particular, fumed silica is preferably used for the purposed of enhancing the strength of the obtained silicone resin cured material and in view of the flow control of the curable silicone resin composition.

The inorganic filler is preferably blended in an amount of 50 parts by mass or less, preferably within the range of 5 to 30 parts by mass per 100 parts by mass of the total of the components (A) to (C).

In the inventive curable silicone resin composition, a viscosity at a strain rate of 1 (1/s) can be 2.0 or more times as much as a viscosity at a strain rate of 10 (1/s), and preferably, the viscosity at a strain rate of 1 (1/s) is 2.5 or more times as much as the viscosity at a strain rate of 10 (1/s). The viscosity (Pa-s) can be measured, for example, at 25° C. by using a rheometer (DHR-3) manufactured by TA Instruments Japan Inc. at a strain rate within the range of 0.01 (1/s) to 1000 (1/s).

### [Additives]

In addition, various additives, for example, components (E) and (F) can be contained in the inventive curable silicone resin composition if necessary, besides the components (A) to (D).

### [(E) Curing Inhibitor]

A curing inhibitor can be contained in the inventive curable silicone resin composition for the purpose of adjusting curing rate and so forth. Examples of the curing inhibitor include vinyl group-highly-containing organopolysiloxanes such as tetramethyltetravinylcyclotetrasiloxane and hexavinyl disiloxane; triallyl isocyanurate, alkyl maleate, acetylene alcohols, and silane-modified products and siloxane-modified products thereof; hydroperoxide, tetramethylethylenediamine, benzotriazole, and compounds selected from the group consisting of mixtures thereof; etc.

When the curing inhibitor is to be blended, usually, 0.001 to 1 parts by mass, preferably 0.005 to 0.5 parts by mass are added per 100 parts by mass of the total of the components (A) to (C).

### [(F) Adhesiveness Imparting Agent]

Besides the above-described components (A) to (E), the inventive curable silicone resin composition may further contain (F) an adhesiveness imparting agent. Examples of the adhesiveness imparting agent (F) include a hydrolysable silyl group and compounds that have a functional group having an affinity and/or reactivity to the adherend. The inventive curable silicone resin composition can be provided with adhesiveness by adding such a compound.

Here, examples of the hydrolysable silyl group include trialkoxysilyl groups such as a trimethoxysilyl group, a triethoxysilyl group, a tripropoxysilyl group, and a triisopropenoxysilyl group; dialkoxyalkylsilyl groups such as a dimethoxymethylsilyl group, a dimethoxyethylsilyl group, a dimethoxyphenylsilyl group, a diethoxymethylsilyl group, a diethoxyethylsilyl group, and a diethoxyphenylsilyl group; etc. Meanwhile, examples of the functional group having an affinity and/or reactivity to an adherend include an epoxy group, an acrylic group, a methacrylic group, an amino group, an N-alkylamino group, an N-arylamino group, a mercapto group, an alkenyl group, a hydrosilyl group, etc.

Examples of the adhesiveness imparting agent (F) include alkoxysilanes and chlorosilanes having a group selected from an epoxy group, a (meth)acrylic group, an amino group, and a mercapto group, and (partial) co-hydrolysis condensates of these; alkoxysilanes having an alkenyl group or a hydrogen atom (hydrosilyl group); alkoxysilyl group-containing isocyanuric acid, cyclic siloxanes having a hydrosilyl group and an alkoxysilyl group and/or an epoxy group; etc.

Examples of the adhesiveness imparting agent (F) include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, N-(2-aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, N-phenyl-3-aminopropyltrimethoxysilane, 3-mercaptopropyltrimethoxysilane, tetramethoxysilane, phenyltrimethoxysilane, diphenyldimethoxysilane, and (partial) co-hydrolysis condensates of these alkoxysilanes and/or corresponding chlorosilanes; vinyltrimethoxysilane, vinyltriethoxysilane, trimethoxysilane, etc.; 1,4-butanediol diacrylate, 1,6-hexanediol diacrylate, 1,9-nonanediol diacrylate, tricyclodecanedimethanol acrylate, polyethylene glycol-modified neopentyl glycol diacrylate, tricyclodecanedimethanol diacrylate, bisphenol A (poly) ethoxy diacrylate, bisphenol A (poly) propoxy diacrylate, bisphenol F (poly)ethoxy diacrylate, ethylene glycol di(meth)acrylate, dioxane glycol diacrylate (e.g. KAYARAD R-604 manufactured by Nippon Kayaku Co., Ltd.), dicyclopentanyl dimethylene diacrylate (e.g. KAYARAD R-684 manufactured by Nippon Kayaku Co., Ltd.), (poly)ethylene glycol diacrylate, diacrylate of an ε-caprolactone adduct of neopentyl glycol hydroxypivalate (e.g. KAYARAD HX-220, HX-620, etc. manufactured by Nippon Kayaku Co., Ltd.), etc.

Furthermore, examples of the adhesiveness imparting agent (F) include compounds obtained by further modifying a cyclic polysiloxane having an isocyanuric ring or a hydrosilyl group shown below with a hydrolysable silyl group and a functional group having an affinity and/or reactivity to the adherend.

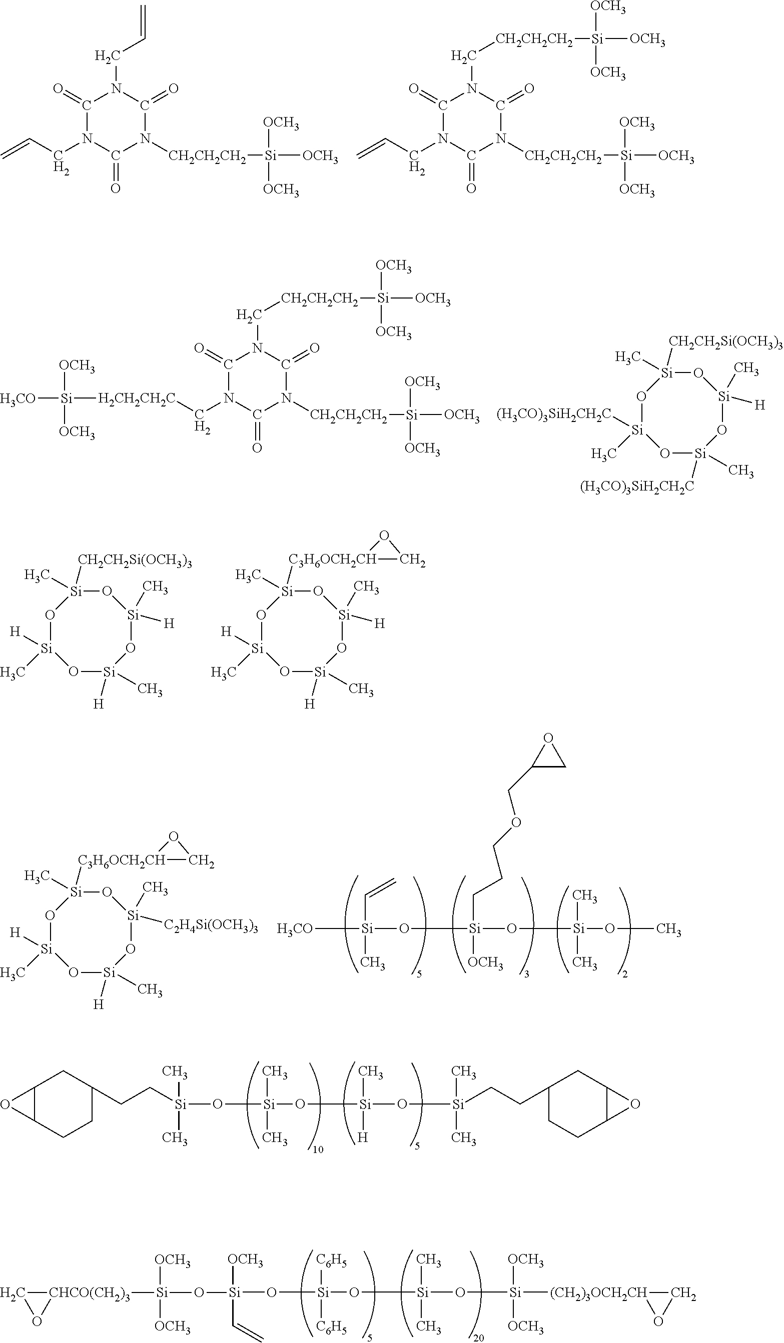

One kind of the adhesiveness imparting agent (F) may be used or two or more kinds thereof may be used in combination. The amount of the adhesiveness imparting agent can be 0.001 to 10 parts by mass, preferably 0.001 to 5 parts by mass relative to a total of 100 parts by mass of the components (A) to (C).

### [Silicone Resin Cured Material]

The inventive curable silicone resin composition can be formed into a silicone resin cured material by applying the curable silicone resin composition onto a prescribed substrate in accordance with the purpose, and then curing the curable silicone resin composition. As curing conditions, examples include a method of heating at 60 to 200° C. and a method of thickening the curable silicone resin composition by irradiation with ultraviolet rays, and then curing the composition by heating at 60 to 200° C.

### [Dam Material]

The inventive curable silicone resin composition can be made into a dam material containing the curable silicone resin composition.

### [Encapsulant]

The inventive curable silicone resin composition can be made into an encapsulant containing the curable silicone resin composition.

### [Semiconductor Device]

The present invention provides a semiconductor device including the silicone resin cured material.

### [Method for Producing Curable Silicone Resin Composition]

A method for producing the inventive curable silicone resin composition is not particularly limited as long as the method includes a step of selecting and providing a linear organopolysiloxane that consists solely of a linear organopolysiloxane having a less than 70% change rate of a contact angle of the linear organopolysiloxane to an Au substrate, the change rate being shown by the expression (I) below. For example, after the step of providing the linear organopolysiloxane, the components (A-1), (A-2), and (D) can be mixed to form a base compound. Next, the components (E) and (C) can be added and mixed, and furthermore, the component (B) can be added and mixed. Thus, the curable silicone resin composition can be produced. The mixing apparatus is not particularly limited, and a known mixing apparatus can be used. However, a planetary mixer or a 3-roll mill is preferable, for example. The components (A-1), (A-2), and (B) may be used after performing thin film evaporation.

[((contact angle of the linear organopolysiloxane to the Au substrate 2 seconds after dropping the linear organopolysiloxane)−(contact angle of the linear organopolysiloxane to the Au substrate 60 seconds after dropping the linear organopolysiloxane))/(contact angle of the linear organopolysiloxane to the Au substrate 2 seconds after dropping the linear organopolysiloxane)]×100(%) (I)

### EXAMPLE

Hereinafter, the present invention will be described in more detail with reference to Examples and Comparative Examples. However, the present invention is not restricted by the following Examples. Note that Ph represents a phenyl group, and “parts” indicates “parts by mass”.

### Example 1

100 parts of a linear organopolysiloxane (viscosity: 700 mPa·s, vinyl group equivalent: 0.050 mol/100 g) represented by the following formula (1-1) as the component (A-1), 40 parts of an organopolysiloxane (2-1) (Mw=4,400, vinyl group equivalent: 0.16 mol/100 g) having a resin structure constituted by 13 mol % of a CH₂═CH(CH₃)PhSiO_{1/2} unit, 30 mol % of a (CH₃)₃SiO_{1/2} unit, 51 mol % of an SiO_{4/2} unit, and 6 mol % of an R²SiO_{4/2} unit (R² represents a methoxy group, an isopropoxy group, and a hydroxy group) as the component (A-2), and 35 parts of nano silica (RX-300 manufactured by NIPPON AEROSIL CO., LTD.) having an average primary particle size of 7 nm as the component (D) were mixed using a planetary mixer. Furthermore, this mixture was kneaded with a 3-roll mill to obtain a base compound. To 175 parts of the obtained base compound, 0.05 parts of 1-ethynyl-1-cyclohexanol was added as the component (E) and sufficiently mixed. Subsequently, 0.1 parts of an octyl alcohol-modified solution of chloroplatinic acid (platinum element content: 1 mass %) was added as the component (C) and mixed. Furthermore, as the component (B), 23.7 parts of an organohydrogenpolysiloxane represented by the following formula (3-1) was added and mixed. Thus, a curable silicone resin composition was prepared.

Note that (1-1), (2-1), and (3-1) were used after performing thin film evaporation.

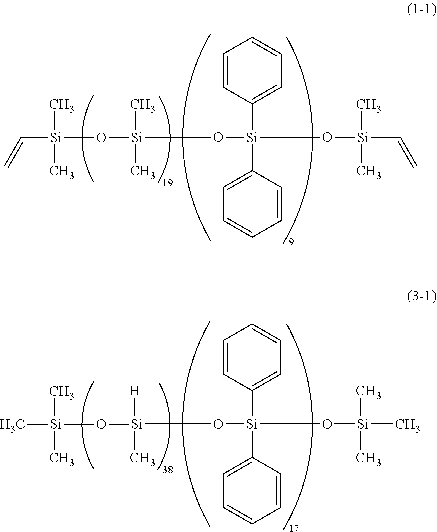

### Example 2

Except that the component (A-1) was changed to 100 parts of a linear organopolysiloxane (viscosity: 1,800 mPa·s, vinyl group equivalent: 0.009 mol/100 g) represented by the following formula (1-3), and that the amount of the component (B) (3-1) added was changed to 15.1 parts in Example 1, Example 1 was repeated to prepare a curable silicone resin composition.

Note that (1-3), (2-1), and (3-1) were used after performing thin film evaporation as in Example 1.

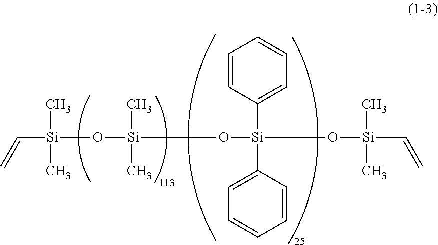

### Example 3

Except that (1-3), (2-1), and (3-1) were used without performing the thin film evaporation in Example 2, Example 2 was repeated to prepare a curable silicone resin composition.

### Example 4

100 parts of (1-1) and 90 parts of a linear organopolysiloxane (viscosity: 4,000 mPa·s, vinyl group equivalent: 0.013 mol/100 g) represented by the following formula (1-2) as the component (A-1), 130 parts of the organopolysiloxane (2-1) having a resin structure as the component (A-2), and 41 parts of nano silica (RX-300 manufactured by NIPPON AEROSIL CO., LTD.) having an average primary particle size of 7 nm as the component (D) were mixed using a planetary mixer. Furthermore, this mixture was kneaded with a 3-roll mill to obtain a base compound. To 361 parts of the obtained base compound, 0.1 parts of 1-ethynyl-1-cyclohexanol was added as the component (E) and sufficiently mixed. Subsequently, 0.2 parts of an octyl alcohol-modified solution of chloroplatinic acid (platinum element content: 1 mass %) was added as the component (C) and mixed. Furthermore, as the component (B), 56 parts of the organohydrogenpolysiloxane represented by (3-1) was added and mixed. Thus, a curable silicone resin composition was prepared.

Note that (1-1), (1-2), (2-1), and (3-1) were used after performing thin film evaporation.

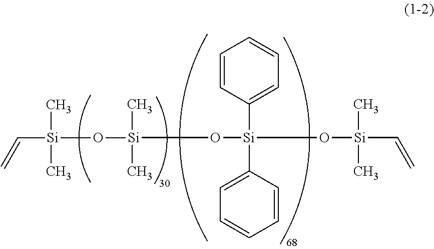

### Example 5

Except that the component (D) was changed to 80 parts in Example 4, Example 4 was repeated to prepare a curable silicone resin composition.

### Example 6

Except that the component (B) was changed to 28 parts in Example 4, Example 4 was repeated to prepare a curable silicone resin composition.

### Example 7

Except that the component (B) was changed to 28 parts in Example 5, Example 5 was repeated to prepare a curable silicone resin composition.

### Comparative Example 1

Except that the component (A-1) was changed to 100 parts of a linear organopolysiloxane represented by the following formula (1-4), the component (A-2) was changed to 40 parts of an organopolysiloxane (2-2) (weight-average molecular weight: 5,200, vinyl group equivalent: 0.095 mol/100 g) having a resin structure constituted by 6.9 mol % of a CH₂═CH(CH₃)₂SiO_{1/2} unit, 37.3 mol % of the (CH₃)₃SiO_{1/2} unit, and 55.8 mol % of the SiO_{4/2} unit, and the component (B) was changed to 3.2 parts of an organohydrogenpolysiloxane (hydrosilyl group equivalent: 1.51 mol/100 g) represented by the following formula (3-2) in Example 1, Example 1 was repeated to prepare a curable silicone resin composition.

Note that the component (A) and the component (B) were used after performing thin film evaporation.

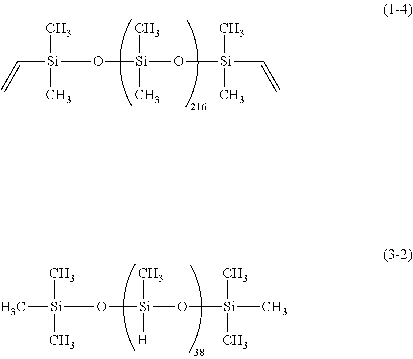

### Comparative Example 2

Except that the components were used without performing thin film evaporation in Comparative Example 1, Comparative Example 1 was repeated to prepare a curable silicone resin composition.

### Comparative Example 3

Except that the component (B) was changed to 3.2 parts of (3-2) in Example 2, Example 2 was repeated to prepare a silicone resin composition.

### Comparative Example 4

30 parts of a linear organopolysiloxane (viscosity: 30,000 mPa·s, vinyl group equivalent: 0.0040 mol/100 g) represented by the following formula (1-6) and 100 parts of a linear organopolysiloxane (viscosity: 5,000 mPa·s, vinyl group equivalent: 0.006 mol/100 g) represented by the following formula (1-5) as the component (A-1), 25 parts of the organopolysiloxane (2-2) (weight-average molecular weight: 5,200, vinyl group equivalent: 0.095 mol/100 g) having a resin structure constituted by 6.9 mol % of the CH₂═CH(CH₃)₂SiO_{1/2} unit, 37.3 mol % of the (CH₃)₃SiO_{1/2} unit, and 55.8 mol % of the SiO_{4/2} unit as the component (A-2), and 10 parts of nano silica (RX-300 manufactured by NIPPON AEROSIL CO., LTD.) having an average primary particle size of 7 nm as the component (D) were mixed using a planetary mixer. Furthermore, this mixture was kneaded with a 3-roll mill to obtain a base compound. To 165 parts of the obtained base compound, 0.05 parts of 1-ethynyl-1-cyclohexanol was added as the component (E) and sufficiently mixed. Subsequently, 0.1 parts of an octyl alcohol-modified solution of chloroplatinic acid (platinum element content: 1 mass %) was added as the component (C) and mixed. Furthermore, as the component (B), 2.4 parts of the organohydrogenpolysiloxane (hydrosilyl group equivalent: 1.53 mol/100 g) represented by the formula (3-2) was added and mixed. Thus, a curable silicone resin composition was prepared.

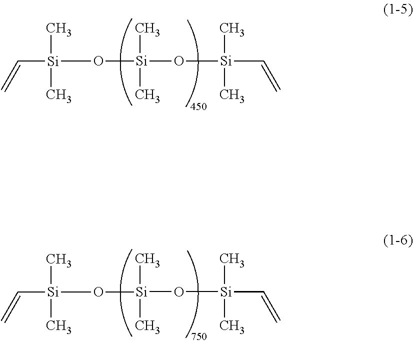

### Comparative Example 5

Except that the component (A-1) was changed to a linear organopolysiloxane (viscosity: 1,000 mPa·s, vinyl group equivalent: 0.013 mol/100 g) represented by the following formula (1-7), and the component (B) (3-1) was changed to 33 parts in Example 2, Example 2 was repeated to prepare a curable silicone resin composition.

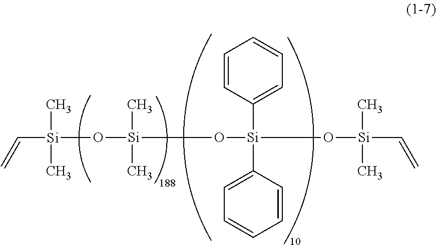

### (1) Measurement of Contact Angle of Linear Organopolysiloxane

Measurement of the contact angle of the linear organopolysiloxanes was conducted as follows. On an Au-plated substrate (surface roughness parameters Sₐ: 0.3 μm, S_{z}: 5 μm), a 4-μl droplet of each organopolysiloxane was dropped onto a sample surface. Using a contact angle meter (automatic surface tensiometer PD-V manufactured by Kyowa Interface Science Co., Ltd.), the contact angle to the Au-plated substrate was measured at 25° C. at a humidity of 50% from 2 seconds after dropping the droplet to 60 seconds after dropping the droplet at 2 second intervals. The contact angle after 2 seconds, the contact angle after 60 seconds, and the change rate of the contact angle has been summarized in Table 1.

### (2) Viscosity

The viscosity at 25° C. (Pa·s) was measured by using a rheometer (DHR-3) manufactured by TA Instruments Japan Inc. at a strain rate within the range of 0.01 (l/s) to 1000 (l/s). Table 2 shows the results.

### (3) Measurement of Volatile Content

1.5 g of each of the curable silicone resin compositions of the Examples and Comparative Examples was individually placed in an aluminum petri dish. Using a hot air circulation dryer, the curable silicone resin compositions were cured by heating at 150° C. for 3 hours. After heating, the container was cooled to 25° C. The mass reduced by the heating was determined, and the volatile content was calculated. Table 2 shows the results.

### (4) Observation of Bleed-Out

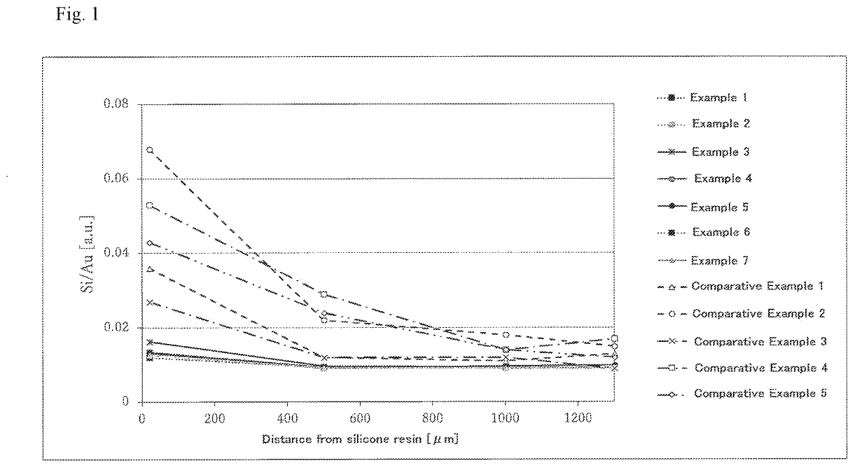

Each of the curable silicone resin compositions of the Examples and Comparative Examples was dispensed onto an Au-plated substrate. This was placed in an airtight aluminum container having a volume of 30 cm³, and using a hot air circulation dryer, was heated at 135° C. for 20 minutes to cure the curable silicone resin composition. After heating, the container was cooled to 25° C. in an airtight state, and the gold-plated plate was taken out of the container. Employing SEM-EDX, the proportions of the detected amount of Si atoms to the detected amount of Au atoms at distances of 20 μm, 500 μm, 1000 μm, and 1300 μm from the silicone resin cured material were calculated. The results are shown in Table 3 and FIG. 1.

TABLE 1

| | | (1-1) | (1-2) | (1-3) | (1-4) | (1-5) | (1-6) | (1-7) | (3-1) | (3-2) |
|---|---|---|---|---|---|---|---|---|---|---|
| Contact | ( i ) 2 | 43 | 43.6 | 44.5 | 38.2 | 47 | 51.2 | 38.2 | 49 | 6.6 |
| angle | seconds | | | | | | | | | |
| [ ° ] | after | | | | | | | | | |
| | dropping | | | | | | | | | |
| | droplet | | | | | | | | | |
| | ( ii ) 60 | 15.7 | 22 | 16.7 | 10.6 | 12.4 | 14.6 | 11.2 | 24.5 | 4.4 |
| | seconds | | | | | | | | | |
| | after | | | | | | | | | |
| | dropping | | | | | | | | | |
| | droplet | | | | | | | | | |

| | | | | | | | | | |
|---|---|---|---|---|---|---|---|---|---|
| Change rate (%) | 63.5 | 49.5 | 62.4 | 70.8 | 73.6 | 71.5 | 70.7 | 56.7 | 77.3 |
| [ { ( i )-( ii ) }/ | | | | | | | | | |
| ( i ) ] × 100 | | | | | | | | | |

TABLE 2

| | | | Example | Example | Example | Example | Example | Example | Example |
|---|---|---|---|---|---|---|---|---|---|
| | | | 1 | 2 | 3 | 4 | 5 | 6 | 7 |
| Blended | A-1 | (1-1) | 100 | — | | 100 | | 100 | |
| number | | (1-2) | — | — | | 90 | | 90 | |
| of parts | | (1-3) | — | 100 | | — | | — | |
| | | (1-4) | — | — | | — | | — | |
| | | (1-5) | — | — | | — | | — | |
| | | (1-6) | — | — | | — | | — | |
| | | (1-7) | — | — | | — | | — | |
| | A-2 | (2-1) | 40 | 40 | | 130 | | 130 | |
| | | (2-2) | — | — | | — | | — | |
| | B | (3-1) | 23.7 | 15.1 | | 56 | | 28 | |
| | | (3-2) | — | — | | — | | — | |
| | C | | 0.1 | 0.1 | | 0.2 | | 0.2 | |
| | D | | 35 | 35 | | 41 | 80 | 41 | 80 |
| | E | | 0.05 | 0.05 | | 0.1 | | 0.1 | |
| | H/Vi | | 1.2 | 1.2 | | 1.2 | | 0.6 | |
| Whether thin film | | | Yes | Yes | No | Yes | Yes | Yes | Yes |
| evaporation was | | | | | | | | | |
| performed on | | | | | | | | | |
| raw materials | | | | | | | | | |
| Viscosity | 10 | | 23 | 102 | 91 | 24 | 164 | 36 | 200 |
| [Pa · s] | (1/s) | | | | | | | | |
| | 1 | | 59 | 729 | 654 | 72 | 1421 | 108 | 1760 |
| | (1/s) | | | | | | | | |
| | 1 | | 2.6 | 7.1 | 7.2 | 3.0 | 8.7 | 3.0 | 8.8 |
| | (1/s)/ | | | | | | | | |
| | 10 | | | | | | | | |
| | (1/s) | | | | | | | | |

| | | | | | | | |
|---|---|---|---|---|---|---|---|
| Volatile | 0.10 | 0.11 | 3.2 | 0.09 | 0.08 | 0.10 | 0.10 |
| content [%] | | | | | | | |

| | | | Comparative | Comparative | Comparative | Comparative | Comparative |
|---|---|---|---|---|---|---|---|
| | | | Example | Example | Example | Example | Example |
| | | | 1 | 2 | 3 | 4 | 5 |
| Blended | A-1 | (1-1) | — | | — | — | — |
| number | | (1-2) | — | | — | — | — |
| of parts | | (1-3) | — | | 100 | — | — |
| | | (1-4) | 100 | | — | — | — |
| | | (1-5) | — | | — | 100 | — |
| | | (1-6) | — | | | 30 | — |
| | | (1-7) | — | | | — | 100 |
| | A-2 | (2-1) | — | | 40 | — | 40 |
| | | (2-2) | 40 | | — | 25 | — |
| | B | (3-1) | — | | — | — | 33 |
| | | (3-2) | 3.2 | | 3.2 | 2.4 | — |
| | C | | 0.1 | | 0.1 | 0.1 | 0.1 |
| | D | | 35 | | 35 | 10 | 35 |
| | E | | 0.05 | | 0.05 | 0.05 | 0.05 |
| | H/Vi | | 1.2 | | 1.2 | 1.2 | 1 |
| Whether thin film | | | Yes | No | Yes | No | Yes |
| evaporation was | | | | | | | |
| performed on | | | | | | | |
| raw materials | | | | | | | |
| Viscosity | 10 | | 30 | 24 | 126 | 63 | 32 |
| [Pa · s] | (1/s) | | | | | | |

| | | | | | |
|---|---|---|---|---|---|
| 1 | 66 | 53 | 921 | 349 | 57 |
| (1/s) | | | | | |
| 1 | 2.2 | 2.2 | 7.3 | 5.5 | 1.8 |
| (1/s)/ | | | | | |
| 10 | | | | | |
| (1/s) | | | | | |

| | | | | | |
|---|---|---|---|---|---|
| Volatile | 0.10 | 0.41 | 0.50 | 0.44 | 0.12 |
| content [%] | | | | | |

TABLE 3

| | Distance | | | | | | |
|---|---|---|---|---|---|---|---|
| | from | | | | | | |
| | resin | Example | Example | Example | Example | Example | Example |
| | [μm] | 1 | 2 | 3 | 4 | 5 | 6 |
| (Detected | 20 | 0.0134 | 0.0128 | 0.0163 | 0.0135 | 0.0132 | 0.0120 |
| amount | 500 | 0.0094 | 0.0094 | 0.010 | 0.0093 | 0.0091 | 0.0093 |
| of Si)/ | 1000 | 0.0094 | 0.0094 | 0.009 | 0.0093 | 0.0096 | 0.0091 |
| (detected | 1300 | 0.0031 | 0.0091 | 1.009 | 0.0091 | 0.0100 | 0.0092 |
| amount | | | | | | | |
| of Au) | | | | | | | |
| | | | Comparative | Comparative | Comparative | Comparative | Comparative |
| | | Example | Example | Example | Example | Example | Example |
| | | 7 | 1 | 2 | 3 | 4 | 5 |
| | (Detected | 0.0127 | 0.036 | 0.068 | 0.027 | 0.053 | 0.043 |
| | amount | 0.0091 | 0.012 | 0.022 | 0.012 | 0.029 | 0.024 |
| | of Si)/ | 0.0091 | 0.011 | 0.018 | 0.012 | 0.014 | 0.014 |
| | (detected | 0.009 | 0.013 | 0.015 | 0.009 | 0.017 | 0.012 |
| | amount | | | | | | |
| | of Au) | | | | | | |

As shown in Table 3 and FIG. 1, in Examples 1 to 7, in which only linear organopolysiloxanes having a contact angle change rate of less than 70% were used, the amount of Si atoms detected by SEM-EDX was small regardless of the values of viscosity and thixotropic index, and excellent results were obtained. On the other hand, in Comparative Examples 1 to 5, in which a linear organopolysiloxane having a contact angle change rate of 70% or more was even partly used, the amount of Si atoms detected by SEM-EDX was large compared with the Examples. That is, bleed-out from the curable silicone resin compositions was observed.

Furthermore, comparing Examples 2 and 3 with Comparative Examples 1 and 2, the amount of Si atoms detected by SEM-EDX was small in Examples 2 and 3 regardless of whether or not the low-molecular-weight siloxanes of the components (A) and (B) were removed, and excellent results were obtained in Examples 2 and 3. On the other hand, in Comparative Examples 1 and 2, the amount of Si atoms detected by SEM-EDX was large even when the low-molecular-weight components were removed. From the above results, it has been revealed that the contact angle change rate of a linear organosiloxane used contributes to bleed-out more than the presence of low-molecular-weight components does.

Accordingly, the inventive curable silicone resin composition can provide a curable silicone resin composition that hardly bleeds out and that hardly contaminates surrounding members.

### INDUSTRIAL APPLICABILITY

When the curable silicone adhesive composition of the present invention is used, bleed-out from the silicon resin hardly occurs when a substrate is coated with the composition, so that there is little contamination of surrounding areas. In particular, when such a silicone resin composition is used for an electronic member, the interference by the silicon component of other members can be suppressed, so that higher density and higher integration of members is possible.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1. A curable silicone resin composition, the composition comprising a linear organopolysiloxane, wherein the linear organopolysiloxane consists solely of a linear organopolysiloxane that has a less than 70% change rate of a contact angle of the linear organopolysiloxane to an Au substrate, the change rate being shown by the following expression (I):
[{(contact angle of the linear organopolysiloxane to the Au substrate 2 seconds after dropping the linear organopolysiloxane)−(contact angle of the linear organopolysiloxane to the Au substrate 60 seconds after dropping the linear organopolysiloxane))/(contact angle of the linear organopolysiloxane to the Au substrate 2 seconds after dropping the linear organopolysiloxane)]×100(%) (I)

2. The curable silicone resin composition according to claim 1, comprising:
(A-1) an organopolysiloxane having at least two alkenyl groups bonded to silicon atoms in one molecule thereof;
(A-2) an organopolysiloxane having a resin structure containing at least two alkenyl groups in one molecule thereof;
(B) an organohydrogenpolysiloxane having at least two hydrogen atoms bonded to silicon atoms, that is, SiH groups in one molecule thereof and having a less than 70% change rate of the contact angle to the Au substrate, the change rate being shown by the expression (I);
(C) a platinum group metal-based catalyst; and
(D) an inorganic filler,
wherein the linear organopolysiloxane is contained as the component (A-1).

3. The curable silicone resin composition according to claim 2, wherein the component (A-2) contains an organopolysiloxane having an alkenyl group-containing resin structure having at least one of an SiO_{4/2} unit and an R¹SiO_{3/2} unit, wherein R¹ represents a substituted or unsubstituted alkyl group having 1 to 10 carbon atoms, an alkenyl group having 2 to 10 carbon atoms, or an aryl group having 6 to 10 carbon atoms.

4. The curable silicone resin composition according to claim 1, wherein a viscosity of the curable silicone resin composition at a strain rate of 1 (1/s) is 2.0 or more times as much as a viscosity at a strain rate of 10 (1/s).

5. The curable silicone resin composition according to claim 2, wherein a viscosity of the curable silicone resin composition at a strain rate of 1 (1/s) is 2.0 or more times as much as a viscosity at a strain rate of 10 (1/s).

6. The curable silicone resin composition according to claim 3, wherein a viscosity of the curable silicone resin composition at a strain rate of 1 (1/s) is 2.0 or more times as much as a viscosity at a strain rate of 10 (1/s).

7. A silicone resin cured material formed by curing the curable silicone resin composition according to claim 1.

8. A silicone resin cured material formed by curing the curable silicone resin composition according to claim 2.

9. A silicone resin cured material formed by curing the curable silicone resin composition according to claim 3.

10. A dam material comprising the curable silicone resin composition according to claim 1.

11. A dam material comprising the curable silicone resin composition according to claim 2.

12. A dam material comprising the curable silicone resin composition according to claim 3.

13. An encapsulant comprising the curable silicone resin composition according to claim 1.

14. An encapsulant comprising the curable silicone resin composition according to claim 2.

15. An encapsulant comprising the curable silicone resin composition according to claim 3.

16. A semiconductor device comprising the silicone resin cured material according to claim 7.

17. A semiconductor device comprising the silicone resin cured material according to claim 8.

18. A semiconductor device comprising the silicone resin cured material according to claim 9.
